(19) United States
(12) Patent Application Publication
(10) Pub. No.: US 2010/0281131 A1
(43) Pub. Date: Nov. 4, 2010

(54) User Interface Between a Flexray Communications Module and a Flexray User, and Method for Transmiting Message Over Such an Interface

(76) Inventors: Johannes HesselBarth, Moeglingen (DE); Berthold Fehrenbacher, Markgroeningen (DE); Christian Wenzel-Benner, Marburg (DE); Rainer Baumgaertner, Pfaffenhofen (DE); Andreas Feicho, Erlenbach (DE)

Correspondence Address: KENYON & KENYON LLP, ONE BROADWAY, NEW YORK, NY, 10004, US

(21) Appl. No.: 12/083,263

(22) PCT Filed: Oct. 4, 2006
(86) PCT No.: PCT/EP2006/067025

§ 371 Date: Jul. 26, 2010

(30) Foreign Application Priority Data
Oct. 6, 2005 (DE) 102005048581.2

(51) Int. Cl. G06F 15/167

(52) U.S. Cl. 709/213; 709/236

(57) ABSTRACT

A user interface between a FlexRay communications module, which is connected to a FlexRay communications connection via which messages are transmitted, and which includes a message memory for the temporary storage of messages from the FlexRay communications connection or for the FlexRay communications connection, and a FlexRay user assigned to the FlexRay communications module. In order to make possible a particularly resource-saving and resource-conserving connection of the user to the FlexRay communications module, it is provided that the user interface has a device for the temporary storage of the messages. The device includes at least one message memory which has a first connection to FlexRay the communications module and a second connection to the user. Message memory may be implemented as a dual-ported RAM.

### FIELD OF THE INVENTION

The present invention relates to a user interface between a FlexRay communications module and a FlexRay user assigned to the FlexRay communications module. The present invention also relates to a method for transmitting messages between a FlexRay communications module and a FlexRay user assigned to the FlexRay communications module via a user interface.

### BACKGROUND INFORMATION

The networking of control units, sensor systems and actuator systems with the aid of a communications system and a communications connection developed as a bus system has increased dramatically in recent years in the construction of modern motor vehicles and also in machine construction, especially in the field of machine tools and in the field of automation. In this context, synergistic effects may be achieved by the distribution of functions to a plurality of control units. These are called distributed systems. The communication between various users is taking place more and more via a communications system designed as a bus system. Communication traffic on the bus system, access and reception mechanisms, as well as error handling are regulated by a protocol.

One known protocol is, for instance, the FlexRay protocol, this currently being based on the FlexRay protocol specification v2.0. The FlexRay protocol defines a rapid, deterministic and fault-tolerant bus system, particularly for use in a motor vehicle. Data transmission according to the FlexRay protocol takes place according to a time division multiple access (TDMA) method. The data transmission via the communications connection takes place in regularly repeating transmission cycles, which are each subdivided into a plurality of data frames, which are also designated as time slots. Fixed time slots are assigned to the users and to the messages to be transmitted, in which they have exclusive access to the communications connection. The time slots repeat in the fixed transmission cycles, so that the instant at which a message is transmitted via the bus can be predicted exactly, and the bus access takes place deterministically.

In order to use the bandwidth for the message transmission on the bus system in optimal fashion, FlexRay subdivides the transmission cycle, which can also be designated as cycle or bus cycle, into a static and a dynamic part. The fixed time slots are in the static portion at the beginning of a bus cycle, in this instance. In the dynamic part, the time slots are assigned dynamically. In that dynamic part, the exclusive bus access is enabled in each case for a short time only, for one or more so-called minislots. The time slot is lengthened by the necessary time only if a bus access takes place within a minislot. Consequently, bandwidth is only used up if it is also actually needed.

FlexRay communicates via two physically separated lines of the communications connection at a data rate of maximally 10 Mbit/s (10 Mbaud), respectively. Every 5 ms a bus cycle is ended in this instance, in some communications systems even every 2.5 ms. The two channels correspond to the physical layer, in particular of the OSI (open system architecture) layer model. The two channels are used chiefly for the redundant and therefore fault-tolerant transmission of messages, but can also transmit different messages, whereby the data rate would then double. However, FlexRay can also be operated at lower data rates.

In order to implement synchronous functions and to optimize the bandwidth by small spacings between two messages, the users and the distributed modules in the communications network thus need a common time base, the so-called global time. For the clock synchronization, synchronization messages are transmitted in the static portion of the cycle, the local clock time of a user being corrected with the aid of a special algorithm according to the FlexRay specification in such a way that all local clocks run synchronously with one global clock.

A FlexRay user, who can also be designated as a FlexRay network node or host, includes a user processor or a host processor, a FlexRay controller or communications controller, as well as a bus guardian, in the case of bus monitoring. The user processor furnishes and processes the data which are transmitted via the FlexRay communications controller and the FlexRay communications connection. Messages or message objects can be configured with, for instance, up to 254 data bytes for communication in a FlexRay network.

In order to couple a FlexRay communications connection, via which messages are transmitted, with a FlexRay user, a FlexRay communications module is used in DE 10 2005 034 744, which had not yet been published on the Application data of the present invention, which is connected via a user interface to the user, and via another connection to the communications connection. For transmission of the messages between the user and the communications connection, in this instance, a device is provided for storing the messages. The transmission is controlled by a state machine.

An interface component made up of two parts is provided in the communications module, the one submodule being user-independent and the other submodule being user-specific. The user-specific submodule, which is also designated as customer CPU interface (CIF), connects a customer-specific user in the form of a user-specific host CPU to the FlexRay communications module. The user-independent submodule, which is also designated as generic CPU interface (GIF), represents a generic, that is, a general CPU interface, via which one may connect different customer-specific host CPU's to the FlexRay communications module using appropriate user-specific submodules, that is, customer CPU interfaces (CIF's).

This makes possible an adaptation, without problem, of the communications module to different users, since only the user-specific submodule has to be varied as a function of the user, while the user-independent submodule and the remaining communications module can always be developed in the same manner. Thus, with the aid of the communications module, there comes about a standard interface for connecting any number of FlexRay users to a FlexRay communications connection, the interface being able to be flexibly adjusted to users developed in any manner or of any nature by simple variation of the user-specific submodule. In this context, that is why the submodules can be implemented in each case in software, that is, each submodule can be implemented as a software function, within the one interface component.

The state machine in the FlexRay communications module can be hardwired in hardware. The sequences can also be hardwired in hardware. Alternatively, the state machine in the communications module can also be freely programmable by the user, via the user interface.

The data may include the access type and/or the access manner and/or the access address and/or the data volume and/or control data on the data and/or at least one datum for data protection.

According to the related art, the message memory of the FlexRay communications module may be developed as a single-ported RAM (random access memory). This RAM memory stores the messages or message objects, that is, the actual useful data, together with configuration data and status data. The exact structure of the message memory of the known communications module can be inferred from the German patent document DE 10 2005 034 744.

It has turned out that the transmission of the messages between the message memory of the FlexRay communications module and the FlexRay user takes place only relatively slowly and while demanding great resources on the part of the users, especially with regard to the required calculating power of the host CPU and the required storage space. In the known user interface between the FlexRay communications module and the FlexRay user, a constant activity of the host CPU (possibly DMA, direct memory access) is required for transferring newly received buffer contents of the message memory of the communications module to the memory of the host CPU. Using so-called polling, the host CPU can regularly check whether new messages have been stored in the message memory of the user interface. Direct access of the host CPU to the message memory of the communications module is not possible. This proves to be disadvantageous, in particular, when the data rate of the FlexRay communications connection is fully exhausted. In addition, one has to reckon with waiting times of the host CPU for setting registers, etc.

### SUMMARY OF THE INVENTION

Therefore, the exemplary embodiments and/or exemplary methods of the present invention is based on the object of providing a FlexRay communications module which optimally supports the communication in a FlexRay network, a particularly resource-saving and resource-conserving connection of the user to the FlexRay communications module being intended to be possible for the user and the user processor.

Starting from the user interface of the type mentioned at the outset, it is provided, for the attainment of this object, that the user interface have a device for the buffer storage of the messages between the FlexRay communications module and the FlexRay user, the device including at least one message memory which has a first connection to the FlexRay communications module and a second connection to the user.

The exemplary embodiments and/or exemplary methods of the present invention relates to a user interface between a FlexRay communications module and a FlexRay user assigned to the FlexRay communications module. The FlexRay communications module is connected to a FlexRay communications connection, via which messages are transmitted. The FlexRay communications module includes a message memory for the buffer storage of messages from the FlexRay communications connection or for the FlexRay communications connection.

The present invention also relates to a method for transmitting messages between a FlexRay communications module and a FlexRay user assigned to the FlexRay communications module via a user interface. The FlexRay communications module is connected to a FlexRay communications connection, via which messages are transmitted. The FlexRay communications module also includes a message memory for the buffer storage of messages from the FlexRay communications connection or for the FlexRay communications connection.

According to the exemplary embodiments and/or exemplary methods of the present invention, an additional message memory is provided in the vicinity of the user interface, to which the content of the message memory of the FlexRay communications module can be transmitted, without, or rather with minimal load. The host CPU of the FlexRay user can directly access at maximum speed the mirrored data in the message memory of the user interface. In the case of a suitable design of the message memory of the user interface, it is even conceivable that the host CPU, even during a transmission cycle, could receive messages or data packets at a suitable location, and release them for transmittal. The entire procedure requires no waiting times with respect to the transmissions into the message memory of the FlexRay communications module, and is only limited by the performance of the interface of the message memory of the FlexRay communications module.

It would be conceivable to integrate the user interface according to the exemplary embodiments and/or exemplary methods of the present invention into the existing FlexRay communications module. However, if the FlexRay communications module has already been certified for the FlexRay or another standard, the entire certification process would have to be run through again, with the integration of a new user interface. In such a case it is recommended that one design the user interface as a separate component or integrate it into the FlexRay user.

That is, according to the exemplary embodiments and/or exemplary methods of the present invention it is provided that the data be transparently transmitted into a temporary memory, the host CPU of the user having access to the buffer storage without delay or with only little delay.

According to one advantageous improvement of the exemplary embodiments and/or exemplary methods of the present invention, it is provided that the message memory of the user interface is developed in such a way that over one of the connections one may access the message memory in a writing or reading manner, and at the same time, over the other of the connections one may access the message memory in a reading or writing manner. The message memory of the user interface is advantageously designed as a dual-port RAM (random access memory having two connections). In a dual-port RAM, reading access is possible from two sides simultaneously. Typical DP RAM types, which are used in the exemplary embodiments and/or exemplary methods of the present invention, are:
the one side of the DP RAM can write, the other side can read,
the one side of the DP RAM can read and write, and the other side can read,
the one side of the DP RAM can read and write, and the other side can write, and
the one side of the DP RAM can read and write, and the other side can read and write.

The first type of DP RAM named above has the lowest hardware expenditure (gate count), and the fourth-named type has the highest hardware expenditure. Without regard to testability, all the provided RAM's would be able to be implemented using the first-named DP RAM type. Possible testability requirements could make the use of one of the above-named second to fourth DP RAM types necessary.

Such memories usually have separate address and data bus systems, as well as an arbitration logic which initiates appropriate measures for collision solution in the case of simultaneous writing operations. Because of the simultaneous access, two otherwise separate systems, namely the FlexRay communications module, on the one hand, and the host CPU of the FlexRay user, on the other hand, are able to work with common data without restricting each other in their access speed.

According to an exemplary embodiment of the present invention, it is provided that the user interface has a state machine which controls a transmission of messages between the message memory of the FlexRay communications module and the message of the user interface in both directions. The state machine, which can also be designated as a finite state machine, ensures that the content of the message memory of the communications module for the host CPU is transmitted invisibly, or rather without assistance of the host CPU, into the message memory (e.g. dual-port RAM) of the user interface.

Furthermore, it is provided that the message memory of the user interface has a writing area in which messages to be transmitted via the FlexRay communications connection are stored, and a reading area in which messages received by the FlexRay communications connection are stored. The designations writing area and reading area were selected from the point of view of the host CPU of the user. Data to be written on the FlexRay data bus and to be transmitted via it are stored in the writing area of the buffer memory, and data received from the FlexRay data bus are written into the reading memory and, from there, are read into the user.

Registers are advantageously assigned to the message memory of the user interface, a writing register may be assigned to the writing area of the message memory and a reading register may be assigned to the reading area of the message memory. The status of the message memory (e.g. dual-port RAM) of the user interface is transmitted via the registers of the state machine to the FlexRay communications module. During reading of the status register, the read bits are reset. The transmitting of the buffers received by the FlexRay communications module is done by the state machine. In this context, the FlexRay communications module signals to the state machine the presence of a buffer content newly received via the user interface. The state machine then assumes the transmission of the buffer content from the FlexRay communications module to the message memory (e.g. dual-port RAM). At the end of the transmission, the state machine indicates the transmission that has taken place in the reading status register, and possibly an interrupt is triggered. By reading out the reading status register, the host CPU can then establish which reading buffers were newly written on by the state machine. The identification, for instance the number, of the buffer that was last successfully transmitted (each separated according to read/write memory) is stored by the state machine in a further register, a so-called write/read position register of the user interface.

The transmission of the buffers written by the host CPU into the message memory, e.g. the dual-port RAM, of the user interface takes place in the same way as the reading. In contrast to reading, the buffer to be sent is determined by the evaluation of the write register. The bit number in the register corresponds to the priority in the transmission. The state machine scans the bits of the register from bottom to top. The corresponding buffer of the bit set to “1” is transmitted by the message memory (e.g. dual-port RAM) into the message memory of the communications module. When the transmission has taken place, the appertaining bit is written into the write register and the buffer number is written into the write/read position register of the user interface. This procedure is carried out continuously. All buffers marked with a “1” are transmitted according to their priority from the message memory (e.g. dual-port RAM) into the message memory of the communications module.

According to an exemplary embodiment of the present invention, the message memory of the user interface has sufficient storage space for storing in it at least the data of one transmission cycle via the FlexRay communications connection. A transmission cycle via the FlexRay communications connection is subdivided into a plurality of data frames, the message memory of the user interface advantageously having sufficient storage space in order to store in it at least the data frames in their maximum size, the so-called buffers, of a transmission cycle. The message memory of the user interface may have sufficient storage space for storing in it 128 data frames in their maximum size (so-called buffers). In this case, then, the registers assigned to the message memory of the user interface have a size of 1 bit per data frame, which may be 128 bits. By setting one bit in the write or read register, the state machine and the host CPU of the user are informed when new data are available for removal in the direction of the message memory of the communications module or in the direction of the memory of the host CPU. For each buffer of the message memory (e.g. dual-port RAM) of the user interface, one bit is available in the write or read register.

As an additional attainment of the object of the exemplary embodiments and/or exemplary methods of the present invention, it is provided, starting from the method of the type named at the outset, that the messages to be transmitted between the FlexRay communications module and the messages to be transmitted to the user are stored temporarily in a configuration of the user interface for the buffer storage of the messages, said configuration including at least one message memory which can be accessed simultaneously by the FlexRay communications module and the user. The synchronous access to the message memory and the register is regulated by an arbiter of the user interface. The latter can also make possible the configuring of the state machine by the host CPU of the user.

Other advantages and advantageous embodiments are derived from the features of the claims and from the specification.

The exemplary embodiments and/or exemplary methods of the present invention is explained in greater detail with reference to the following figures of the drawings.

### BRIEF DESCRIPTION OF THE DRAWINGS

FIG. 1 shows a communications module and its connection to a communications connection and a communications user or host user of a FlexRay communications system in a schematic representation.

FIG. 2 shows a special specific embodiment of the communications module from FIG. 1, as well as its connection in detail.

FIG. 3 shows the structure of a message memory of the communications module in FIG. 2.

FIGS. 4, 5 and 6 show the architecture and the process of a data access in the direction of the user to the message memory, in a schematic representation.

FIGS. 7, 8 and 9 show the architecture and the process of a data access in the direction from the message memory to the user.

FIG. 10 shows the structure of a message handler and of finite state machines included therein, in a schematic representation.

FIG. 11 shows component parts of the communications module of FIGS. 1 and 2, as well as the user and the corresponding data paths controlled by the message handler, in a schematic representation.

FIG. 12 shows the access distribution to the message memory with reference to the data paths in FIG. 11.

FIG. 13 shows a user interface according to the present invention, according to a first exemplary embodiment of the present invention.

FIG. 14 shows a user interface according to the present invention, according to a second exemplary embodiment of the present invention.

FIG. 15 shows a sequence diagram of a method according to the present invention, for transmitting messages from an input memory.

FIG. 16 shows a sequence diagram of a method according to the present invention, for transmitting messages from a transmitter memory.

### DETAILED DESCRIPTION

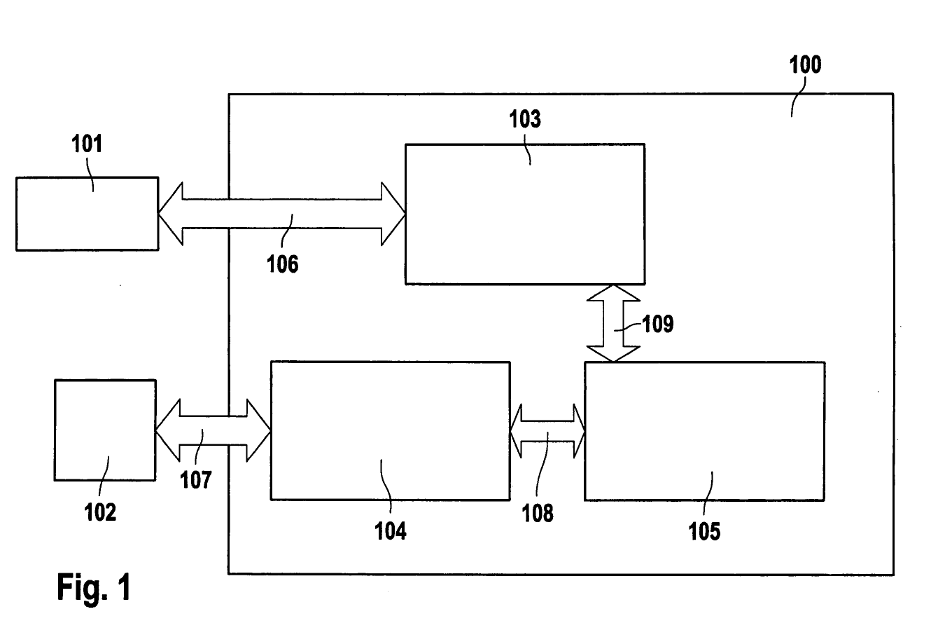

FIG. 1 shows schematically a FlexRay communications module 100 for connecting a user or host 102 to a FlexRay communications link 101, that is, the physical layer of the FlexRay. To that end, FlexRay communications module 100 is connected via a connection 107 to the user or user processor 102, and via a connection 106 to communications link 101. For problem-free connection first of all with respect to transmission times, and secondly with respect to data integrity, essentially three configurations are schematically differentiated in the FlexRay communications module. In this context, a first configuration 105 is used for storage, in particular as a clipboard, of at least a portion of the messages to be transmitted. Between user 102 and this first configuration 105, a second configuration 104 is connected via connections 107 and 108. In the same way, a third configuration 103 is connected via connections 106 and 109 between user 101 and first configuration 105, a very flexible input and output of data as part of messages, particularly FlexRay messages into and out of first configuration 105 thereby being attainable at optimal speed, while ensuring the data integrity.

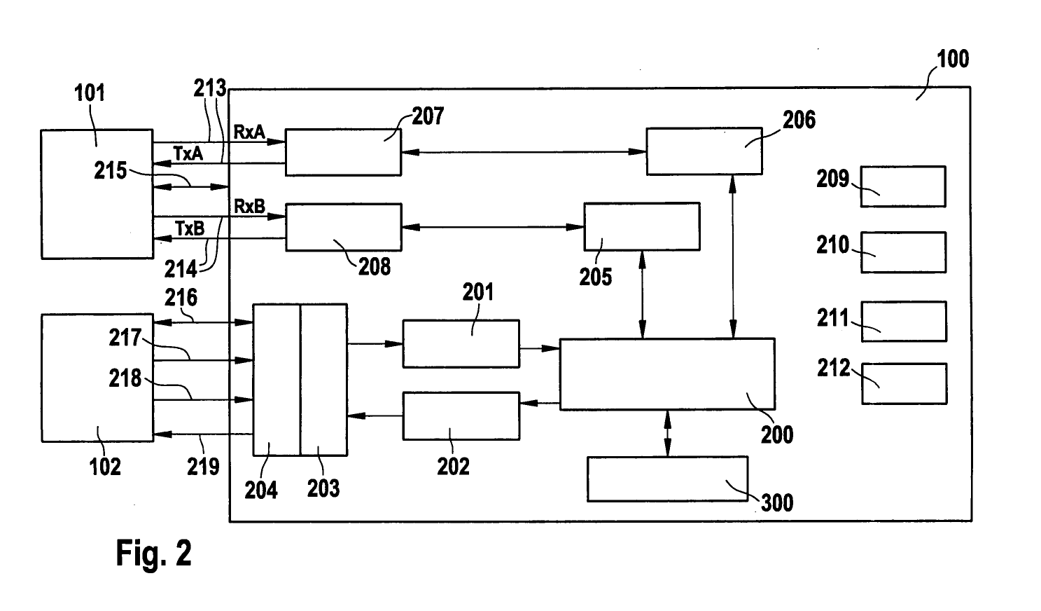

In FIG. 2, this communications module 100 is shown again in greater detail in an exemplary embodiment. Respective connections 106 through 109 are shown in greater detail as well. In order to connect FlexRay communications module 100 to FlexRay user 102 or the host processor, second configuration 104 includes an input buffer (IBF) 201, an output buffer (OBF) 202, as well as an interface module made up of two parts 203 and 204, the one submodule 203 being user-independent, and second submodule 204 being user-specific. User-specific sub-module 204 (customer CPU interface CIF) connects a use-specific host CPU 102, that is, a customer-specific user, to the FlexRay communications module. To that end, a bidirectional data line 216, an address line 217 and a control input 218 are provided. An interrupt output denoted by 219 is likewise provided. User-specific submodule 204 is connected to a user-independent submodule 203 (generic CPU interface, GIF); that is, the FlexRay communications module or the FlexRay IP module has a generic, that is, a general CPU interface 203, to which a large number of different customer-specific host CPUs 102 can be connected via corresponding user-specific submodules 204, that is, customer CPU interfaces CIF. In this manner, only sub-module 204 must be varied as a function of user 102, which means a markedly lower expenditure. CPU interface 203 and remaining communications module 100 can be taken over unchanged.

Input buffer 201 and output buffer 202 may be formed in one common memory module or else in separate memory modules. Input buffer 201 is used for the buffer storage of messages for transmission to message memory 300. Input buffer module 201, in this instance, may be designed in such a way that it is able to store two complete messages, each made up of a header segment, in particular having configuration data, and a data segment or payload segment. Input buffer 201 is in two parts (partial buffer and shadow memory), which means that transmission between user CPU 102 and message memory 300 can be accelerated by writing the two parts of input buffer 201 by turns, or, by alternating access. In the same way, output buffer (OBF) 202 is used for the buffer storage of messages for transmission from message memory 300 to user CPU 102. Output buffer 202 is also configured in such a way that two complete messages made up of header segment, particularly having configuration data, and data segment, that is, payload segment, are able to be stored. Here, as well, output buffer 202 is subdivided into two parts, a partial buffer and a shadow memory, which means transmission between user or host CPU 102 and message memory 300 may also be accelerated here by reading the two parts alternately, or, by access alternation. This second configuration 104, made up of blocks 201 through 204, is connected to first configuration 105, as shown.

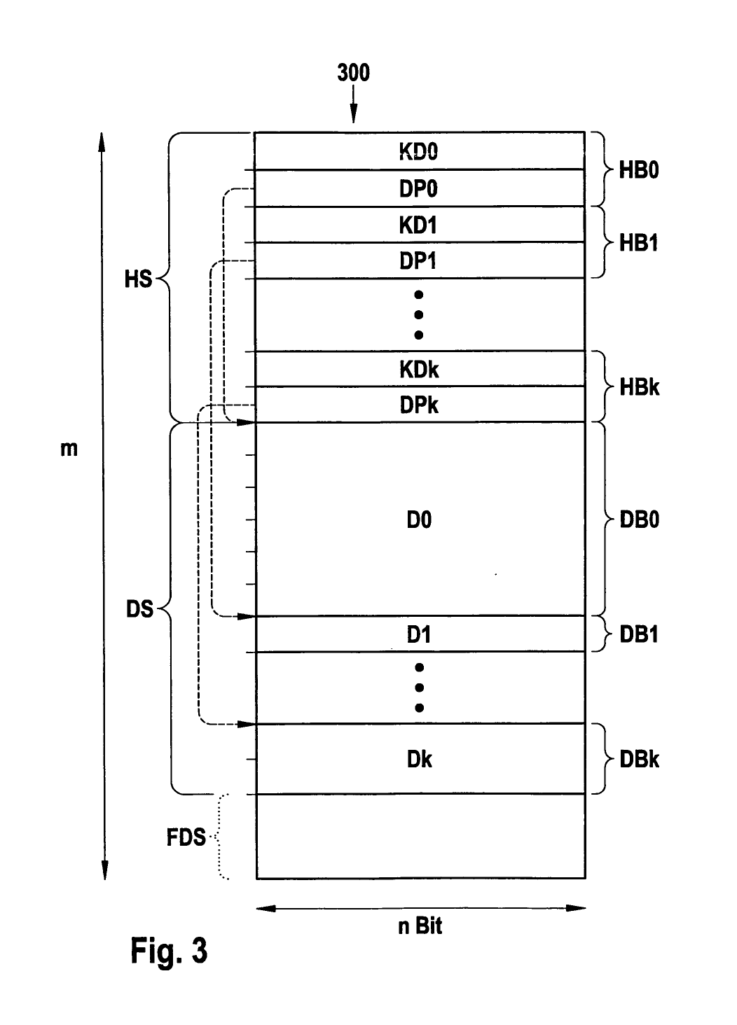

Configuration 105 is made up of a message handler (MHD) 200 and a message memory 300 (message RAM). Message handler 200 checks or controls the data transfer between input buffer 201 as well as output buffer 202, and message memory 300. In like manner, it checks or controls the data transmission in the other direction via third configuration 103. Message memory 300 may be implemented as a single-ported RAM. This RAM memory stores the messages or message objects, that is, the actual data, together with configuration data and status data. The exact structure of message memory 300 is shown in greater detail in FIG. 3.

Third configuration 103 is made up of blocks 205 through 208. Corresponding to the two channels of the FlexRay physical layer, this configuration 103 is divided into two data paths, each having two data directions. This becomes clear through connections 213 and 214, wherein the two data directions are shown for channel A by RxA and TxA for reception (RxA) and for transmission (TxA), as well as for channel B, by RxB and TxB. An optional bidirectional control input is denoted by connection 215. Third configuration 103 is connected via a first buffer 205 for channel B and a second buffer 206 for channel A. These two buffers (transient buffer RAMs: RAM A and RAM B) are used as buffer storage for the data transmission from or to first configuration 105. Corresponding to the two channels, these two buffers 205 and 206 are connected to an interface module 207 and 208, respectively, which contain the FlexRay protocol controller or bus protocol controller made up of a transmit/receive shift register and the FlexRay protocol finite state machine. Therefore, the two buffers 205 and 206 are used as buffer storage for the data transmission between the shift registers of the interface modules or FlexRay protocol controller 207 and 208 and message memory 300. The data fields, that is, the payload segment or data segment of two FlexRay messages, are advantageously stored by each buffer 205 or 206 here, as well.

Also shown in communications module 100 is the global time unit (GTU), designated by 209, which is responsible for the representation of the global time-slot pattern in the FlexRay, that is, the microtick μT and the macrotick MT. The fault-tolerant clock synchronization of the cycle counter and the control of the time sequences in the static and dynamic segment of the FlexRay are regulated via global time unit 209, as well. Block 210 represents the general system control (system universal control SUC) by which the operation modes of the FlexRay communications controller are checked and controlled. They include the wake-up, the startup, the reintegration or integration, normal operation and passive operation.

Block 211 shows the network and error management NEM as described in the FlexRay protocol specification v2.0. Finally, block 212 shows the interrupt control (INT) which manages the status and error interrupt flags and checks or controls interrupt outputs 219 to user CPU 102. In addition, block 212 contains an absolute and a relative timer for generating the time interrupts or timer interrupts.

Message objects or messages (message buffer) can be configured with up to 254 data bytes for the communication in a FlexRay network. In particular, message memory 300 is a message RAM which, for example, is able to store up to a maximum of 128 message objects. All functions which relate to the handling or management of the messages themselves are implemented in message handler 200. They are, for example, the acceptance filtering, transfer of messages between the two FlexRay protocol controller blocks 207 and 208 and message memory 300, that is, the message RAM, as well as the control of the transmit sequence and the providing of configuration data and status data, respectively.

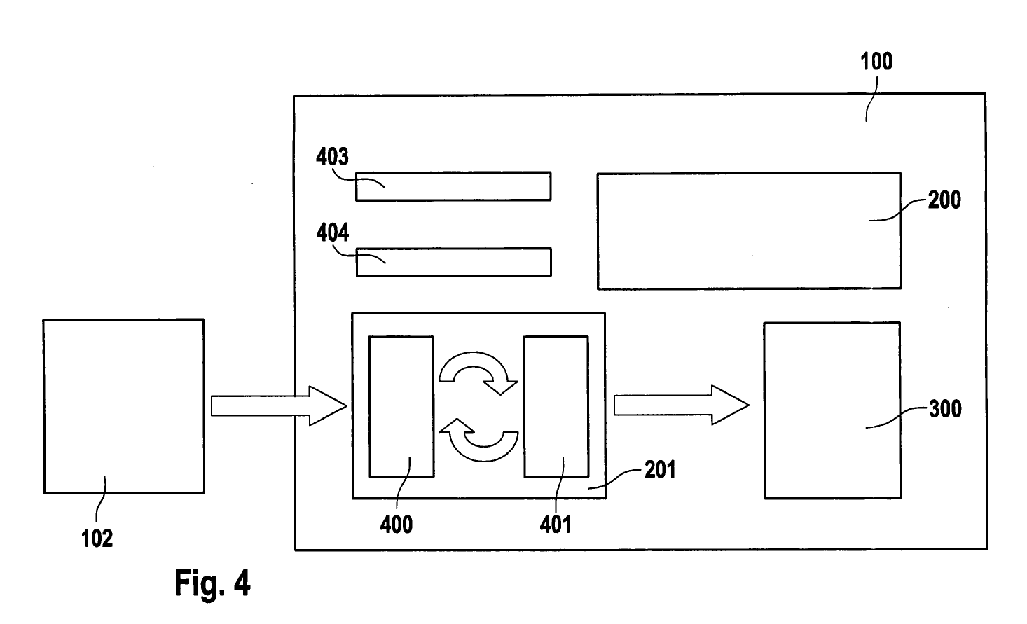

An external CPU, that is, an external processor, user processor 102, is able to directly access the register of FlexRay communications module 100 via user interface 204, using user-specific part 204. In this context, a plurality of registers is used. These registers are employed to configure and control the FlexRay protocol controller, that is, interface modules 207 and 208, message handler (MHD) 200, global time unit (GTU) 209, system universal controller (SUC) 210, network and error management unit (NEM) 211, interrupt controller (INT) 212, as well as the access to the message RAM, that is, message memory 300, and to indicate the corresponding status, as well. At least parts of these registers are discussed in greater detail in FIGS. 4 through 6 and 7 through 9. Such a described FlexRay communications module 100 permits easy implementation of FlexRay specification v2.0, whereby an ASIC or a microcontroller having corresponding FlexRay functionality may easily be generated.

Because of described FlexRay communications module 100, the FlexRay protocol specification, especially v2.0, can be fully supported and, with that, for instance up to 128 messages or message objects can be configured. This yields a flexibly configurable message memory for storing a different number of message objects as a function of the size of the respective data field or data area of the message. Consequently, that is, advantageously messages objects or message objects are to be configured which have data fields of different lengths. Message memory 300 is advantageously developed as FIFO (first in, first out), in this instance, so that a configurable reception FIFO comes about. Each message and each message object in the memory can be configured as a receive buffer, transmit buffer or as a part of the configurable receive FIFO. Acceptance filtering for frame ID, channel ID and cycle counter is also possible in the FlexRay network. The network management is consequently supported in an expedient manner. In addition, maskable module interrupts are advantageously provided.

FIG. 3 shows the partitioning of message memory 300 in detail. For the functionality of a FlexRay communications controller required according to the FlexRay protocol specification, a message memory is needed for making available messages to be transmitted (transmit buffer Tx), as well as for storing messages received without error (receive buffer Rx). A FlexRay protocol allows messages having a data area, that is a payload area, of 0 to 254 bytes. As FIG. 2 shows, message memory 300 is part of FlexRay communication module 100. The method described in the following, as well as corresponding message memory 300, illustrate the storage of messages to be sent and of received messages, particularly using a random access memory (RAM), the mechanism described making it possible to store a variable number of messages in a message memory of specified size. The number of messages able to be stored is a function of the size of the data areas of the individual messages, which means first of all, it is possible to minimize the size of the memory needed without limiting the size of the data areas of the messages, and secondly, the memory is optimally utilized. This variable partitioning of, in particular, a RAM-based message memory 300 for a FlexRay communications controller shall now be described in greater detail below. For the implementation, a message memory having a stipulated word length of n bits, e.g., 8, 16, 32, etc., as well as a predefined memory depth of m words (m, n as natural numbers) is now specified by way of example. In this instance, message memory 300 is partitioned into two segments, a header segment HS and a data segment DS (payload section, payload segment). Thus, one header area HB and one data area DB are created per message. Therefore, for messages 0, 1 through k (k as natural number), header areas HB0, HB1 through HBk and data areas DB0, DB1 through DBk are created. Thus, first and second data are differentiated in a message, the first data corresponding to configuration data and/or status data with respect to the FlexRay message, and in each case being put down in a header area HB (HB0, HB1, . . . , HBk). The second data, which correspond to the actual payload data to be transmitted, are put down accordingly in data areas DB (DB0, DB1, . . . , DBk). Thus, a first scope of data (measured in bits, bytes or memory words) is created for the first data per message, and a second scope of data (likewise measured in bits, bytes or memory words) is created for the second data of a message; the second scope of data being able to be different per message. The partition between header segment HS and data segment DS is now variable in message memory 300, i.e., no predefined boundary exists between the areas. The partition between header segment HS and data segment DS is a function of the number k of messages, as well as of the second scope of data, that is, the scope of the actual payload data, of one message or of all k messages together. A pointer element or data pointer DP0, DP1 through DPk is now in each case assigned directly to configuration data KD0, KD1 through KDk of the respective message. In the special embodiment, a fixed number of memory words, here two, is assigned to each header area HB0, HB1 through HBk, so that one configuration datum KD (KD0, KD1, . . . , KDk) and one pointer element DP (DP0, DP1, . . . , DPk) are always filed together in one header area HB. Following this header segment HS having header areas HB, whose size or first scope of data is a function of the number k of messages to be stored, is data segment DS for storing actual message data D0, D1 through Dk. This data segment (or data section) DS is dependent in its scope of data on the respective scope of data of the message data filed, here, for example, six words in DB0, one word in DB1 and two words in DBk. Therefore, respective pointer elements DP0, DP1 through DPk always point to the beginning, that is, at the start address of the respective data area DB0, DB1 through DBk in which data D0, D1 through Dk of respective messages 0, 1 through k are stored. Consequently, the partitioning of message memory 300 between header segment HS and data segment DS is variable and is a function of the number k of messages themselves as well as the specific scope of data of a message, and therefore the entire second scope of data. If fewer messages are configured, header segment HS becomes smaller and the area becoming free in message memory 300 may be used as supplement to data segment DS for the storage of data. This variability ensures optimal storage utilization, thereby also permitting the use of smaller memories. Free data segment FDS, particularly its size, likewise a function of the combination of the number k of stored messages and the specific second scope of data of the messages, is therefore minimal and may even become 0.

In addition to the use of pointer elements, it is also possible to store the first and second data, that is, the configuration data KD (KD0, KD1, . . . , KDk) and actual data D (D0, D1, . . . , Dk) in a specifiable sequence, so that the sequence of header areas HB0 through HBk in header segment HS and the sequence of data areas DB0 through DBk in data segment DS are in each case identical. It could then even be possible, under certain circumstances, to dispense with a pointer element.

In one special refinement, the message memory is assigned an error-identifier generator, particularly a parity bit generator element, and an error-identifier checker, particularly a parity bit check element, to ensure the correctness of the stored data in HS and DS, in that one checksum may be co-stored, especially as a parity bit, per memory word or per area (HB and/or DB). Other check identifiers, e.g., a CRC (cyclic redundancy check) or even identifiers of greater power such as ECC (error code correction) are conceivable. Consequently, the following advantages result compared to a fixed partitioning of the message memory:

In programming, the user is able to decide whether he/she would like to use a larger number of messages having a small data field or a smaller number of messages having a large data field. In the configuration of messages having a data area DB of variable size, the available memory space is optimally utilized. The user has the possibility of utilizing one data-memory area jointly for different messages.

In the implementation of the communication controller on an integrated circuit, it is possible to adjust the size of message memory 300 by adapting the memory depth (the number m of words) of the memory used, to the requirements of the application, without altering the other functions of the communication controller.

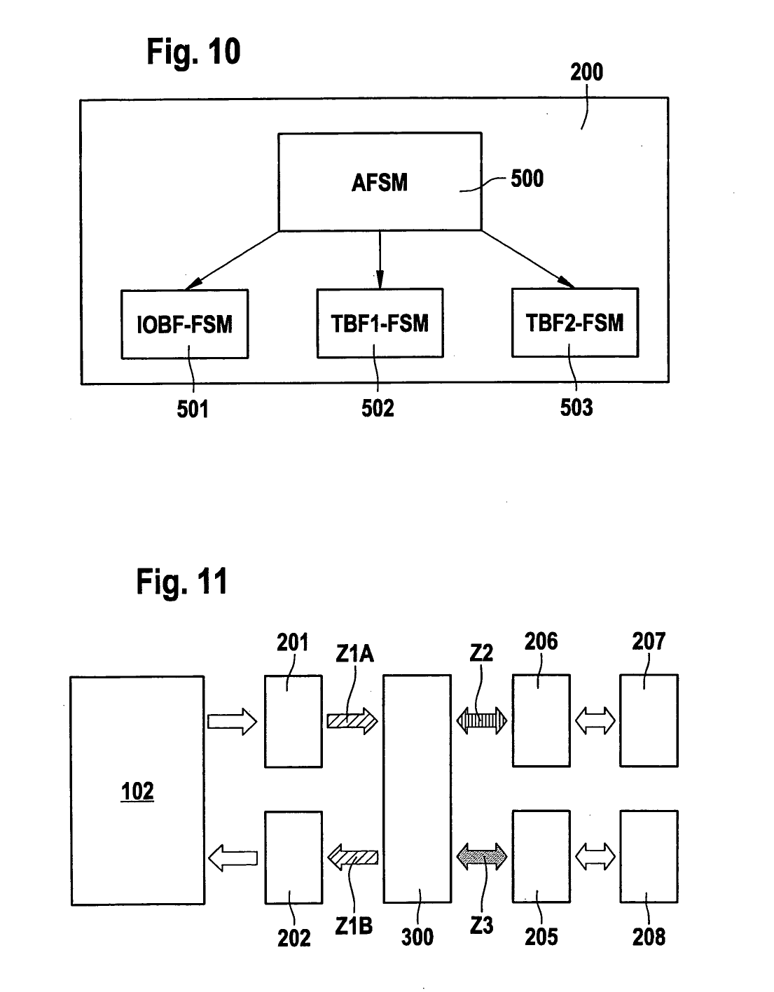

In the following, the host CPU access, that is, the writing and reading of configuration data and status data, respectively, and the actual data via buffer configuration 201 and 202 is now described in greater detail with reference to FIGS. 4 through 6 and 7 through 9. In so doing, the goal is to produce a decoupling with respect to the data transmission, such that the data integrity may be made certain, and at the same time a high transmission rate is ensured. These operations are controlled via message handler 200, which is described later in greater detail in FIGS. 10, 11 and 12.

The write accesses to message memory 300 by the host CPU of user CPU 102, via input buffer 201 is first explained in greater detail in FIGS. 4, 5 and 6. For that purpose, FIG. 4 again shows communications module 100, only the parts of communication module 100 relevant here being shown for reasons of clarity. They are, first of all, message handler 200 responsible for controlling the operational sequences, as well as two control registers 403 and 404 which, as shown, may be accommodated outside of message handler 200 in communications module 100, but may also be contained in message handler 200 itself. 403 represents the input buffer command request register, and 404 represents the input buffer command mask register. Thus, write accesses by host CPU 102 to message memory 300 (message RAM) take place via an interposed input buffer 201. This input buffer 201 is now designed in a divided or duplicated manner, and specifically as partial buffer 400 and a shadow memory 401 belonging to the partial buffer. Consequently, as described below, a continuous access of host CPU 102 to the messages or message objects, or rather data of message memory 300 is able to be accomplished, and with that, data integrity and accelerated transmission are ensured.

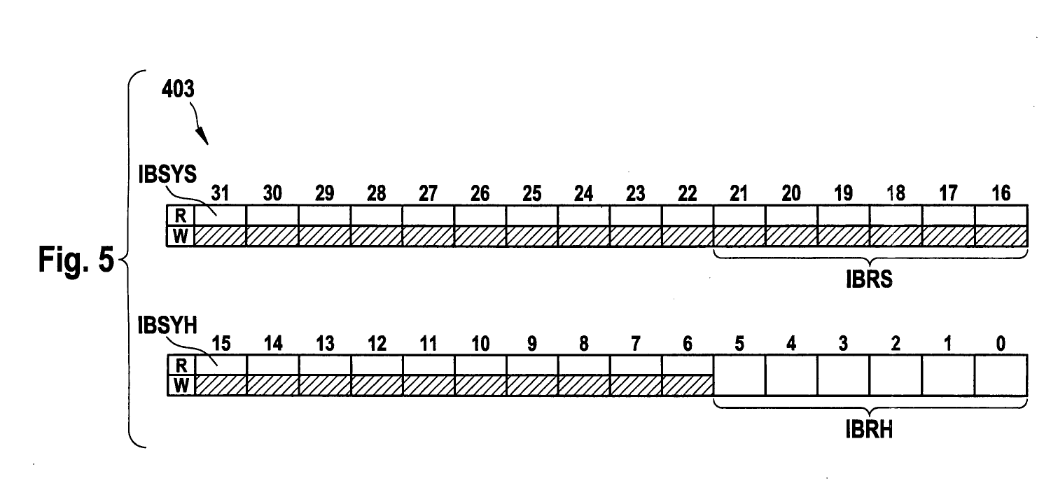

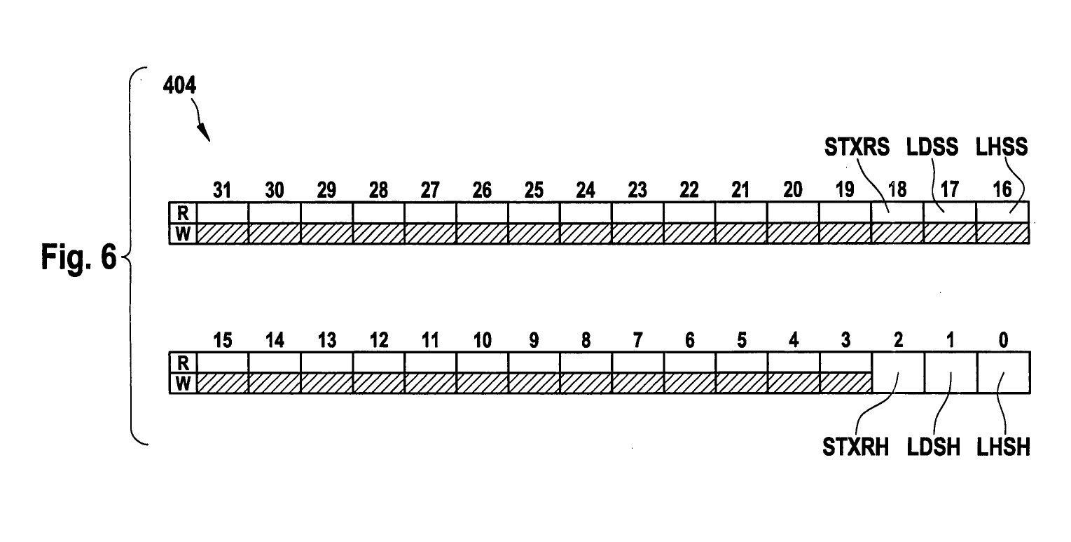

The accesses are controlled via input buffer command request register 403, and via input buffer command mask register 404. In register 403, the numbers from 0 through 31 represent the respective bit positions in 403 in FIG. 5, here, by way of example, for a width of 32 bits. The same holds true for register 404, and bit positions 0 through 31 in masking register 404 of FIG. 6.

As example, bit positions 0 through 5, 15, 16 through 21 and 31 of register 403 are now given a special function with respect to the sequence control. Thus, an identifier IBRH (input buffer request host) is able to be entered as message identifier into bit positions 0 through 5 of register 403. In the same way, an identifier IBRS (input buffer request shadow) is able to be entered into bit positions 16 through 21 of register 403. IBSYH is entered into register position 15 of 403, and IBSYS is entered into register position 31 of 403 as access identifiers, as well. Positions 0 through 2 of register 404 are also marked, further identifiers being entered as data identifiers in 0 and 1 with LHSH (load header section host) and LDSH (load data section host). These data identifiers are in the simplest form here, namely, each takes the form of one bit. In bit position 2 of register 404, a start identifier is written in with STXRH (set transmission X request host). In the following, the sequence of the write access to message memory 300 via input buffer 201 is now described.

Host CPU 102 writes into input buffer 201, the data of the message to be transferred. In so doing, host CPU 102 is able to write only the configuration and header data KD of a message for header segment HS of message memory 300, or only the actual data D of a message that are to be transmitted for data segment DS of message memory 300, or both. Which part of a message, that is, configuration data and/or the actual data, is to be transmitted is established by special data identifiers LHSH and LDSH in input buffer command mask register 404. In this context, LHSH (load header section host) establishes whether the header data, that is, configuration data KD, are to be transmitted, and LDSH (load data section host) establishes whether data D are to be transmitted. Because input buffer 201 is designed in two parts having a partial buffer 400 and an associated shadow memory 401, and a two-way alternate access is intended to take place, two further data-identifier areas, which are now related to shadow memory 401, are provided as counterpart to LHSH and LDSH. These data identifiers in bit positions 16 and 17 of register 404 are denoted by LHSS (load header section shadow) and LDSS (load data section shadow). They therefore control the transmission process with respect to shadow memory 401.

If the start bit or start identifier STXRH (set transmission X request host) is now set in bit position 2 of input buffer command mask register 404, then after the configuration data and/or actual data to be transmitted have in each case been transferred into message memory 300, a transmission request is automatically set for the corresponding message object. That is to say, the automatic sending of a transmitted message object is controlled, in particular started, by this start identifier STXRH.

Correspondingly, the counterpart to this for the shadow memory 401 is start identifier STXRS (set transmission X request shadow) which, for example, is contained in bit position 18 of input buffer command mask register 404, and here in the simplest case is likewise in the form of one bit. The function of STXRS is analogous to the function of STXRH, merely specific to shadow memory 401.

When host CPU 102 writes the message identifier, especially the number of the message object in message memory 300 into which the data of input buffer 201 are to be transferred, into bit positions 0 through 5 of input buffer command request register 403, that is, according to IBRH, partial buffer 400 of input buffer 201 and associated shadow memory 401 are exchanged, or the respective access of host CPU 102 and message memory 300 to the two partial memories 400 and 401 is exchanged, as indicated by the semicircular arrows. In so doing, for example, the data transfer, that is, the data transmission to message memory 300 is started, as well. The data transmission to message memory 300 itself is accomplished from shadow memory 401. At the same time, register areas IBRH and IBRS are exchanged. LHSH and LDSH are exchanged for LHSS and LDSS, as well. Likewise, STXRH is exchanged with STXRS. Therefore, IBRS shows the identifier of the message, that is, the number of the message object for which a transmission, that is, a transfer from shadow memory 401 is in operation, i.e., which message object, that is, which area in message memory 300 has received, as the last event, data (KD and/or D) from shadow memory 401. By the identifier (here again, for example, 1 bit) IBSYS (input buffer busy shadow) in bit position 31 of input buffer command request register 403, it is indicated whether a transmission with involvement of shadow memory 401 is taking place at the moment. Thus, for example, in the case of IBSYS=1, transmission is taking place from shadow memory 401 at the moment, and in the case of IBSYS=0, it is not. For example, this bit IBSYS is set by the writing of IBRH, that is, bit positions 0 through 5 in register 403 in order to indicate that a transfer between shadow memory 401 and message memory 300 is in operation. After this data transmission to message memory 300 has ended, IBSYS is reset again.

While the data transfer from shadow memory 401 is just in process, host CPU 102 is able to write the next message to be transferred into input buffer 201 or into partial buffer 400. With the aid of a further access identifier IBSYH (input buffer busy host), e.g., in bit position 15 of register 403, the identifier may be even further refined. If host CPU 102 is just writing IBRH, that is, bit positions 0 through 5 of register 403, while a transmission between shadow memory 401 and message memory 300 is in progress, that is, IBSYS=1, then IBSYH is set in input buffer command request register 403. As soon as the current transfer, that is, the current transmission is concluded, the requested transfer (request through STXRH, see above) is started, and bit IBSYH is reset. Bit IBSYS remains set during the entire time to indicate that data are being transferred to message memory 300. All bits used in all the exemplary embodiments may also be in the form of identifiers having more than one bit. A one-bit solution is advantageous for economic reasons from the standpoint of memory and processing.

The mechanism thus described allows host CPU 102 to continually transfer data into the message objects located in message memory 300 and made up of header area HB and data area DB, assuming the access speed of host CPU 102 to input buffer 201 is less than or equal to the internal data-transfer rate of the FlexRay IP module, that is of communications module 100.

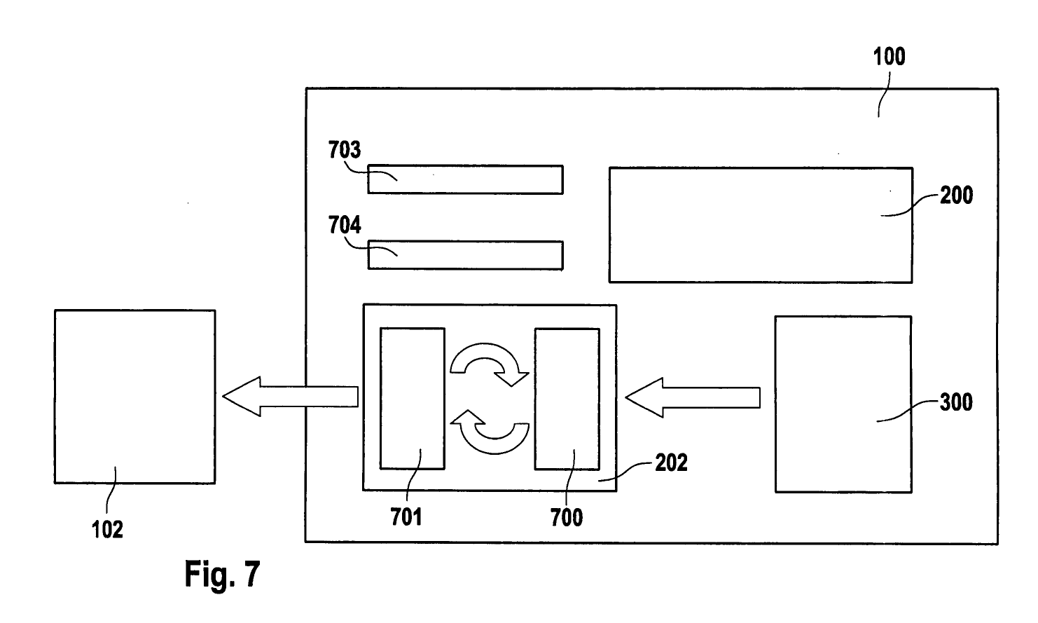

The read accesses to message memory 300 by host CPU or user CPU 102 via output buffer 202 are now elucidated in FIGS. 7, 8 and 9. For that purpose, FIG. 7 again shows communications module 100, for reasons of clarity, only the relevant parts of communications module 100 being shown here, as well. They are, first of all, message handler 200 responsible for controlling the operational sequences, as well as two control registers 703 and 704 which, as shown, may be accommodated outside of message handler 200 in communications module 100, but may also be contained in message handler 200 itself. 703 represents the output buffer command request register, and 704 represents the output buffer command mask register. Thus, read accesses by host CPU 102 to message memory 300 take place via interposed output buffer 202. This output buffer 202 is now likewise designed in a divided or duplicated manner, and specifically as partial buffer 701 and a shadow memory 700 belonging to the partial buffer.

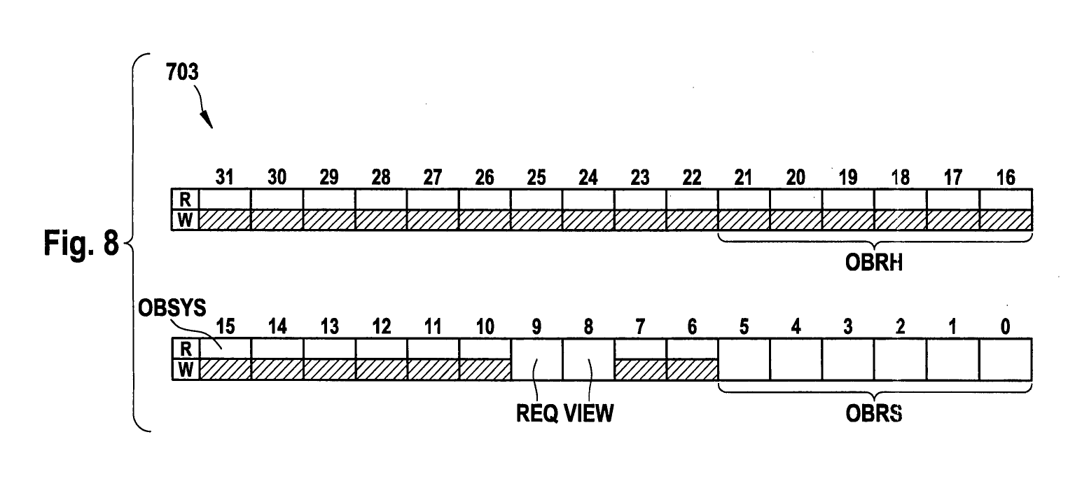

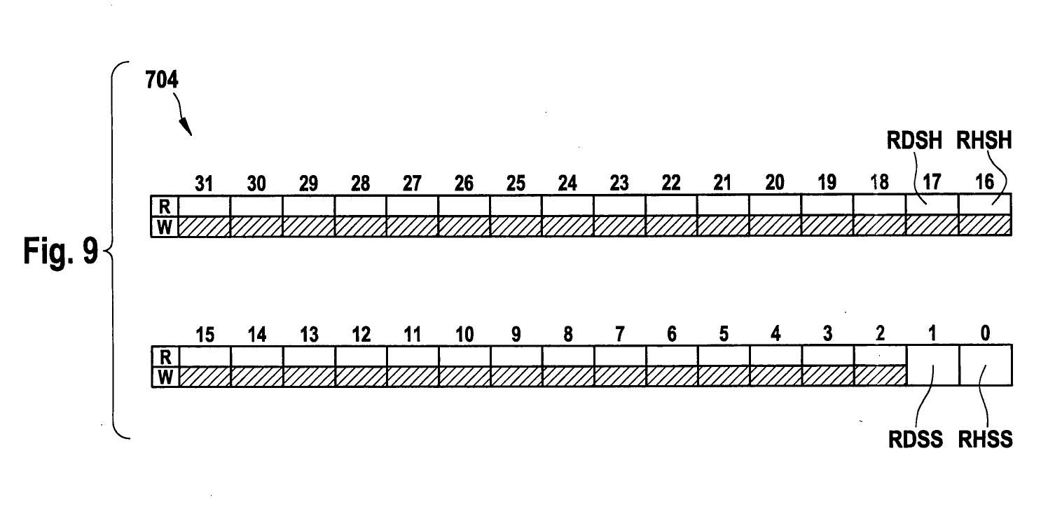

Consequently, as described below, a continuous access by host CPU 102 to the messages or message objects, or rather data of message memory 300 is able to be accomplished here, as well, and with that, data integrity and accelerated transmission are now ensured in the reverse direction from message memory 300 to host 102. The accesses are controlled via output buffer command request register 703, and via output buffer command mask register 704. Also in register 703, the numbers from 0 through 31 represent the respective bit positions in 703, here, by way of example, for a width of 32 bits (cf. FIG. 8). The same holds true for register 704 and bit positions 0 through 31 in 704 (cf. FIG. 9).

As an example, bit positions 0 through 5, 8 and 9, 15 and 16 through 21 of register 703 are now given a special function with respect to the sequence control of the read access. Thus, an identifier OBRS (output buffer request shadow) is able to be entered as message identifier into bit positions 0 through 5 of register 703. In the same way, an identifier OBRH (output buffer request host) is able to be entered into bit positions 16 through 21 of register 703. An identifier OBSYS (output buffer busy shadow) is able to be entered as access identifier into bit position 15 of register 703. Positions 0 and 1 of output buffer command mask register 704 are also marked, further identifiers being entered as data identifiers into bit positions 0 and 1 with RDSS (read data section shadow) and RHSS (read header section shadow). Additional data identifiers are provided, for example, in bit positions 16 and 17 with RDSH (read data section host) and RHSH (read header section host). These data identifiers are also in the simplest form here by way of example, namely, each takes the form of one bit. A start identifier REQ is entered into bit position 9 of register 703. A switchover identifier VIEW is also provided, which is entered by way of example in bit position 8 of register 703.

Host CPU 102 requests the data of a message object from message memory 300 by writing the identifier of the desired message, thus, in particular, the number of the desired message object, according to OBRS, that is, into bit positions 0 through 5 of register 703. As in the reverse direction, in this case host CPU 102 may also either read only the status or configuration data and header data KD of a message, that is, from a header area, or may only read data D of a message actually to be transmitted, that is, from the data area, or also both. Thus, which part of the data is to be transmitted from the header area and/or data area is established, in this instance, in a manner comparable to the reverse direction by RHSS and RDSS. That is to say, RHSS indicates whether the header data are to be read, and RDSS indicates whether the actual data are to be read.

A start identifier is used to start the transmission from message memory 300 to shadow memory 700. That is, if, as in the simplest case, one bit is used as identifier, the transmission from message memory 300 to shadow memory 700 is started by setting bit REQ in bit position 9 in output buffer command request register 703. The active transmission is again indicated by an access identifier, here again in the simplest case by one bit OBSYS in register 703. To avoid collisions, it is advantageous if bit REQ can only be set when OBSYS is not set, thus no active transmission is taking place at the moment. The message transfer between message memory 300 and shadow memory 700 then also takes place here. The actual operational sequence could now, on the one hand, be controlled in a manner comparable to the reverse direction as described under FIGS. 4, 5 and 6 (complementary register occupancy) and carried out, or else, in a variation, by an additional identifier, namely, a switchover identifier VIEW in bit position 8 of register 703. That is, after the transmission is completed, bit OBSYS is reset, and partial buffer 701 and associated shadow memory 700 are exchanged, i.e., the accesses to them are exchanged, by setting the bit VIEW in output buffer command request register 703, and host CPU 102 is now able to read out the message object requested from message memory 300, that is, the corresponding message, from partial buffer 701. In this context, comparable to the reverse transmission direction in FIGS. 4 through 6, register cells OBRS and OBRH are exchanged here, as well. RHSS and RDSS are likewise exchanged for RHSH and RDSH. As a protective mechanism, it is also possible to provide here that the bit VIEW can only be set when OBSYS is not set, that is, no active transmission is taking place.

Therefore, read accesses by host CPU 102 to message memory 300 take place via an interposed output buffer 202. Just like input buffer 201, this output buffer 202 has a duplicate or double design to ensure a continuous access of host CPU 102 to the message objects which are stored in message memory 300. The advantages of high data integrity and accelerated transmission are achieved here, as well.

The use of input and output buffers 201, 202 described ensures that a host CPU 102 is able to access message memory 300 without interruption in spite of the module-internal latency times.

To guarantee this data integrity, the data transmission, especially the forwarding in communications module 100, is undertaken by message handler (MHD) 200. To that end, message handler 200 is shown in FIG. 10. Message handler 200 is displayable in its functionality by a plurality of state machines or state automatons, that is, finite automatons referred to as finite state machines (FSM). In this instance, at least three finite state machines are provided, and in one special specific embodiment, four finite state machines are provided. A first finite state machine is the IOBF-FSM (input/output buffer state machine), designated by 501. This IOBF-FSM could also be subdivided into two finite state machines, per transmission direction with respect to the input buffer 201 or the output buffer 202, IBF-FSM (input buffer FSM) and OBF-FSM (output buffer FSM); a maximum of five state automatons (IBF-FSM, OBF-FSM, TBF1-FSM, TBF2-FSM, AFSM) would thereby be conceivable. However, one joint IOBF-FSM may be provided. In accordance with an exemplary embodiment, a second finite state machine is subdivided here into two blocks 502 and 503 and operates the two channels A and B with respect to memories 205 and 206, as described regarding FIG. 2. In this context, one finite state machine may be provided to operate both channels A and B, or else, as in the described form, one finite state machine TBF1-FSM designated by 502 (transient buffer 1 (206, RAM A) state machine) for channel A, and one TBF2-FSM designated by 503 (transient buffer 2 (205, RAM B) state machine) for channel B.

In an exemplary embodiment, an arbiter finite state machine, referred to as AFSM and denoted by 500, is used to control the access of the three finite state machines 501-503. The data (KD and/or D) are transmitted in a clock pulse, generated by a clock-pulse arrangement such as a VCO (voltage controlled oscillator), a quartz-crystal oscillator, etc., or adapted from it, in the communications module 100. In this context, clock pulse T may be generated in the module or predefined from outside, e.g., as bus timing. Arbiter finite state machine AFSM 500 gives access to message memory 300 by turns to one of the three finite state machines 501-503, particularly in each instance for one clock-pulse period T. That is, the time available is distributed in accordance with the access requests by individual state automatons 501, 502, 503, to these requesting state automatons. If only one finite state machine requests access, then it receives 100% of the access time, that is, all clock pulses T. If two finite state machines request access, then each finite state machine receives 50% of the access time. Finally, if three state automatons request access, then each of the finite state machines receives ⅓ of the access time. The bandwidth available in each case is thereby optimally utilized.

First finite state machine 501, that is, IOBF-FSM, carries out the following actions as needed:
Data transfer from input buffer 201 to the selected message object in message memory 300.
Data transfer from the selected message object in message memory 300 to output buffer 202.

Finite state machine 502 for channel A, that is, TBF1-FSM, carries out the following actions:
Data transfer from the selected message object in message memory 300 to buffer 206 of channel A.
Data transfer from buffer 206 to the selected message object in message memory 300.
Search for the appropriate message object in message memory 300; upon reception, the message object (receive buffer) being sought for storage of a message, received on channel A, within the framework of an acceptance filtering, and upon sending, the next message object (transmit buffer) to be sent on channel A is sought.

The action of TBF2-FSM, that is, of the finite state machine for channel B in block 503, is analogous thereto. It carries out the data transfer from the selected message object in message memory 300 to buffer 205 of channel B, and the data transfer from buffer 205 to the selected message object in message memory 300. The search function for an appropriate message object in message memory 300 is also analogous to TBF1-FSM; upon reception, the message object (receive buffer) is sought for storage of a message, received on channel B, within the framework of an acceptance filtering, and upon transmission, the next message or message object (transmit buffer) to be transmitted on channel B.

The operational sequences and the transmission paths are now shown once more in FIG. 11. The three finite state machines 501-503 control the respective data transmissions between the individual parts. The host CPU is again represented by 102, the input buffer by 201, and the output buffer by 202. The message memory is represented by 300, and the two buffers for channel A and channel B are represented by 206 and 205. Interface elements 207 and 208 are likewise shown. First state automaton IOBF-FSM, designated by 501, controls data transfer Z1A and Z1B, thus from input buffer 201 to message memory 300 and from message memory 300 to output buffer 202. The data are transmitted via data buses having a word length of, e.g., 32 bits, any other bit number also being possible. The same holds true for transmission Z2 between the message memory and buffer 206. This data transmission is controlled by TBF1-FSM, that is, state machine 502 for channel A. Transmission Z3 between message memory 300 and buffer 205 is controlled by state automaton TBF2-FSM, that is, 503. Here, as well, the data are transferred via data buses with a word length of, e.g., 32 bits, any other bit number likewise being possible here. Normally, the transfer of a complete message object via the indicated transmission paths requires a plurality of clock-pulse periods T. Therefore, the transmission time is divided specific to clock-pulse periods T by the arbiter, i.e., AFSM 500. Thus, FIG. 11 shows the data paths between the memory components controlled by message handler 200. To ensure the data integrity of the message objects stored in message memory 300, advantageously, data should be exchanged at the same time on only one of the paths shown, thus Z1A and Z1B as well as Z2 and Z3.

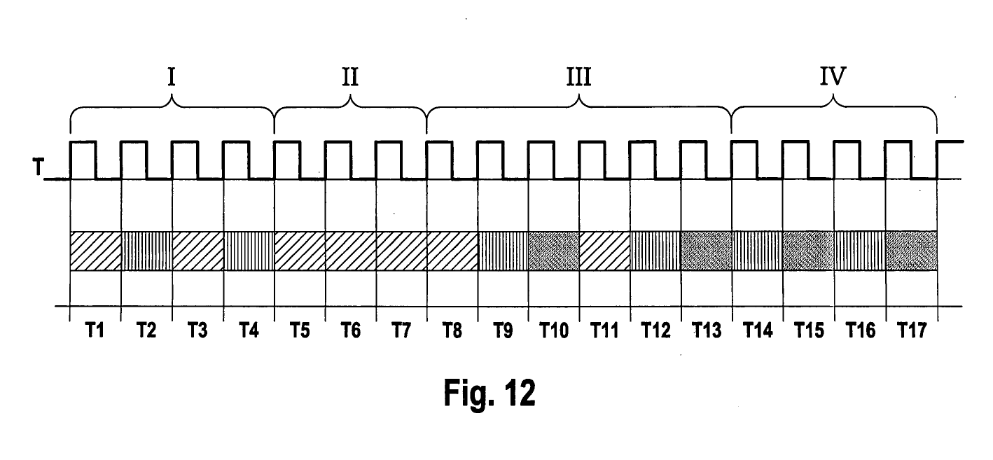

FIG. 12 shows, by way of example, how the available system clock pulses T are distributed by the arbiter, that is, AFSM 500, to the three requesting state automatons. In phase 1 (I), access requests are made by state automaton 501 and state automaton 502, i.e., that the entire time be distributed one half each to the two requesting state automatons. Specific to the clock-pulse periods in phase 1 (I), this means that finite state machine 501 receives access in clock-pulse periods T1 and T3, and finite state machine 502 receives access in clock-pulse periods T2 and T4. In phase 2 (II), access is made only by state machine 501, so that all three clock-pulse periods, that is 100% of the access time from T5 through T7 is allotted to IOBF-FSM. In phase 3 (III), access requests are made by all three state automatons 501 through 503, so that the total access time is divided into thirds. For example, arbiter AFSM 500 then distributes the access time so that finite state machine 501 receives access in clock-pulse periods T8 and T11, finite state machine 502 receives access in clock-pulse periods T9 and T12, and finite state machine 503 receives access in clock-pulse periods T10 and T13. Finally, in phase 4 (IV), access is carried out by two state automatons 502 and 503 on the two channels A and B of the communications module, so that an access distribution of clock-pulse periods T14 and T16 to finite state machine 502 is implemented, and in T15 and T17 to finite state machine 503.

Thus, arbiter finite state automat AFSM 500 ensures that, for the case when more than one of the three finite state machines 501-503 makes a request for access to message memory 300, the access is distributed with clock-pulse timing and in alternation to requesting finite state machines 501-503. This procedure ensures the integrity of the message objects stored in message memory 300, that is, the data integrity. For example, if host CPU 102 wants to read out a message object via output buffer 202 while at the moment a received message is being written into this message object, then depending upon which request was started first, either the old state or the new state is read out, without the accesses in the message object in message memory 300 itself colliding.

The method described permits host CPU 102, during continuous operation, to read or to write any message object in message memory 300 without the selected message object being blocked from participation in the data exchange on both channels of the FlexRay bus 101 for the duration of the access by the host CPU (buffer locking). At the same time, by the interleaving of the accesses with clock-pulse timing, the integrity of the data stored in message memory 300 is ensured, and the transmission rate is also increased by utilization of the full bandwidth.

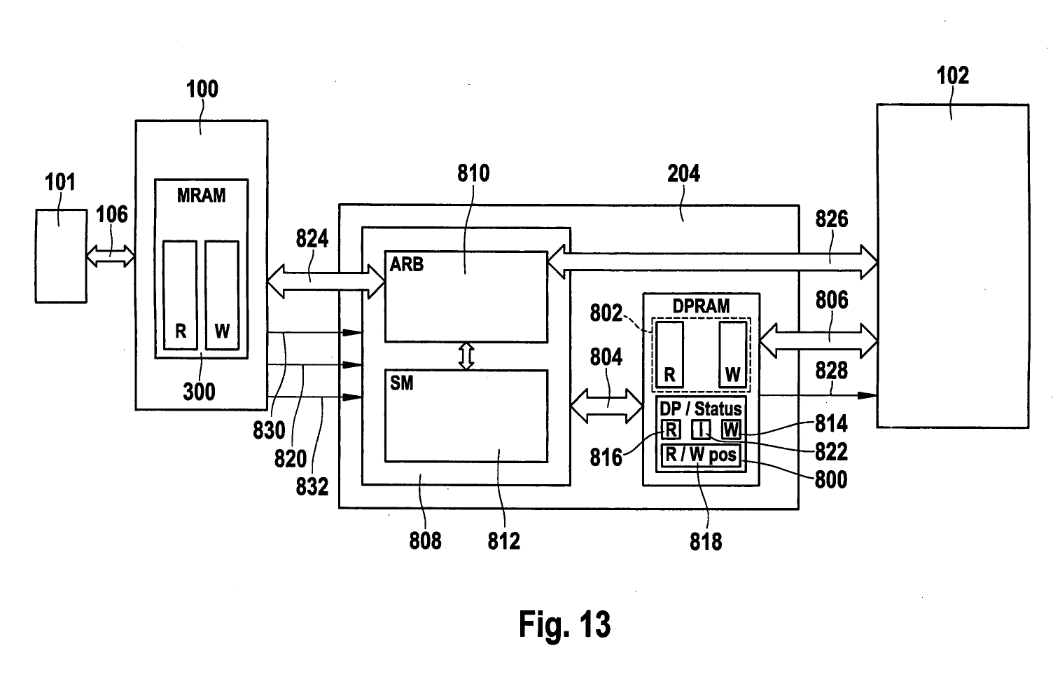

In order for FlexRay communications module 100 to support the sommunication in the FlexRay network in optimal fashion, and in order to be able to connect FlexRay communications module 100 to the user, in a method that is particularly resource-saving and resource-conserving, according to the exemplary embodiments and/or exemplary methods of the present invention, a specially designed user interface 204 is provided, which is shown in detail in FIG. 13. Interface 204 has a device 800 for the temporary storage of the messages to be transmitted between FlexRay communications module 100 and FlexRay user 102. Device 800 includes at least one message memory 802 which has a first connection 804 to FlexRay communications component 100 and a second connection to the user 102. Message memory 802 of memory device 800 may be developed as a dual-ported RAM. It includes a write area (W), in which the messages to be transmitted via FlexRay communications connection 101 are stored, and a read area (R), in which messages received by FlexRay communications connection 101 are stored. Message memory 802 is developed to be at least so big that it has enough memory space for storing all the messages of a bus cycle. Memory 802 may have enough memory space for 128 buffers (maximum size of a data frame (so-called frames)).

In addition, user interface 204 has a second device 808 in which an entity 810 (arbiter ARB) regulates the access sequence to message memory 802 of user interface 204, to ensure the data integrity, and which includes at least one state machine (SM) 812. Using state machine 812, the content of message memory 300 of FlexRay communications module 100 are is transmitted into DPRAM message memory 802 of interface 204, for user 102 or the host CPU. Host CPU can access directly the mirrored data in DPRAM 102 with maximum speed.

Data, addresses and control data are exchanged between communications module 100 and bus arbiter 810 of user interface 204, via a connection 824, which is, for example, developed as a bus system. Data, addresses and control data are exchanged between bus arbiter 810 of user interface 204 and user 102 or the host CPU, via a connection 826, which is, for example, developed as a bus system. Data, addresses and control data are exchanged between memory device 800 of user interface 204 and user 102 or the host CPU, via a connection 806, which is, for example, developed as a bus system. Between arbiter 810 and state machine 812, data, addresses and control date are exchanged via a connection 834 which can be developed as a bus system. Via a connection 828, an interrupt can be transmitted to user 102 or the host CPU, as soon as in memory 802 a buffer has been received from message memory 300 of communications module 100 (DPBuffer_received_Int signal). The beginning of a new bus cycle is communicated (new_cycle signal) to state machine 812 of interface 204, via connection 830. Via a connection 820, it is communicated to state machine 812 of interface 204 that a new buffer has been received (buffer_received signal) in message memory 300 of communications module 100, and it induces state machine 812 to transmit this new buffer into message memory 802 of interface 204. Finally, state machine 812 receives a clock-pulse signal, via a connection 832, from communications module 100 for controlling and coordination of its activity with the remaining operational sequences in the overall system 100, 101, 102, 204.

Registers are assigned to message memory 802 of user interface 204, a write register (DP/status register W) 814 may be assigned to write area W of message memory 802, and a read register (DP/status register R) 816 may be assigned to write area R of message memory 802. The status of message memory 802 of user interface 204 is transmitted to FlexRay communications module 100 via registers 814, 816 by state machine 812. The size of status registers 814, 816 may depend on the size of message memory 802 and the number of messages that are able to be stored temporarily in it. When the size of memory 802 is 128 buffers, registers 814, 816 may have a size of 128 bits, each bit of registers 814, 816 in each case being assigned one buffer of memory 802. During the reading of the status register, the read bits are reset. The identification, for instance the number, of the buffer that was last successfully transmitted by state machine 812 (each separated according to read/write memory) is stored by state machine 812 in a further register 818, a so-called write/read position register of user interface 204.

Host CPU 102 can receive data packets at a suitable location and release them for transmission, even during a bus cycle, under control by the two dual-port status registers (DP status) 814, 816. This means that, with the aid of state machine 812, an optimization or a limited preprocessing of the messages to be stored in temporary memory 802 can be undertaken within one bus cycle, so as to further speed up access to the stored messages. The preprocessing of the messages may be limited to formalities and the external part of the messages, for instance, the position in which the messages are stored in message memory 802. An analysis of the content of the messages and a corresponding content-dependent preprocessing does need not occur. The host CPU has optional access to the content of message memory 300 of FlexRay communications module 100, via user interface 204, according to the exemplary embodiments and/or exemplary methods of the present invention.

The entire procedure about storing messages in message memory 802 and retrieving messages from message memory 802 requires no waiting times with respect to data transmission. The transmission speed or transmission rate is only limited by the performance of the DPRAM interface of message memory 802. A topical manipulation of buffers is possible.

For the initiation of a data transmission from message memory 802 (e.g. DP RAM) of user interface 204 to message memory 300 (e.g. MRAM) of communications module 100, host CPU 102 sets a bit in write register (DP/status register W) 814.

For the buffers to be transmitted by state machine 812 to communications module 100, host CPU 102 writes appropriate identifiers into write register (DP/status/W register) 814, for instance, by setting corresponding bits for the buffers to be transmitted. State machine 812 transfers all the buffers marked in write registers 814 (e.g. by setting a bit) into message memory 300 of communications module 100.

A data transmission from message memory 300 (e.g. MRAM) of communications module 100 to message memory 802 (e.g. DP RAM) of user interface 204 is initiated by communications module 100 by a buffer/received signal. After state machine 812 has asked for the buffer to be transmitted by communications module 100, it transmits it from message memory 300 (e.g. MRAM) to message memory 802 (e.g. DP RAM). At the end of the transmission, state machine 812 sets the corresponding bit in read register 816 (DP/status register R). In addition, at the end of the transmission, state machine 812 can still trigger an interrupt to host CPU 102.

The transmission of the buffers written by host CPU 102 into message memory 802 of user interface 204 takes place in the same way as the reading. In contrast to reading, the buffer to be sent is determined by the evaluation of read register 816 (DP/status/R register). The bit number in register 816 corresponds to the priority in the transmission. State machine 812 scans the bits of register 816 from bottom to top.

The corresponding buffer to the first bit set to “1” is transmitted from message memory 802 of user interface 204 into message memory 300 of communications module 100. When the transmission has taken place, the appertaining bit is written into read register 816 and the buffer number is written into write/read position register (DP/R-pos register) 818. This procedure is carried out continuously. All buffers marked “1” are transmitted according to their priority from message memory 802 to message memory 300 of communications module 100.

In the exemplary embodiment of FIG. 13, FlexRay communications module 100 and user interface 204 according to the present invention are two separate modules. For the data transfer between message memory 300 of communications module 100 and message memory 802 of user interface 204, state machine 812, without the assistance of host CPU 102, transfers the buffers of message memory 300 of communications module 100 into message memory 802 of user interface 204. DPRAM 802 is directly connected to state machine 812 on one side and to host CPU 102 on the other side. Both sides are able to access DPRAM 802 without delay. The status of DPRAM 802 is transmitted by state machine 812 to host CPU 102 via DP/status/R register 816. The buffers to be transmitted by state machine 812 to communications module 100 are written by host CPU 102 into DP/status/W register 814. After the host CPU write access, register 814 contains the binary OR of its previous content and the written data. State machine 812 transfers all the buffers marked in DP/status/W register 814 into message memory 300 of FlexRay communications module 100. The number of the last successfully transmitted buffer by state machine 812 (in each case separated as to R buffer and W buffer) is stored by state machine 812 in R/W-pos register 818. Bus arbiter 810 permits the synchronous access by both state machine 812 and host CPU 102 to registers 814, 816 of interface 204.

State machine 812 directly accesses registers of communications module 100 assigned to message memory 300, (via arbiter 810). After communications module 100 indicates, via a buffer/received signal 820, a buffer newly received from communications connection 101, state machine 812 actively asks for the buffer number by access to the registers of communications module 100. Subsequently, state machine 812 ascertains the buffer attributes (buffer address in buffer memory 300 of communications module 100, length of the buffer, etc.) by reading out the corresponding register communications module 100. After the necessary transfer data are present in state machine 812, the communications module is prompted to the view command of the buffer in the transfer window of communications module 100. In the last step, state machine 812 automatically transmits the buffer content of memory 300 into message memory 802. At the end of the buffer transmission, the corresponding R bit is set in DP-status register 816, and the buffer number is written into DP/R-pos register 818. The setting of the DP-status register R bits can trigger an interrupt to host CPU 102, as a function of the interrupt mask (DP-status-I-register 822 having 128 bits), which is transmitted via interrupt connection 828 to host CPU 102. This procedure is repeated for each transmitted buffer. The method according to the present invention also works without interrupt, of course, so that interrupt register 822 and interrupt connection 828 can be omitted. Independent of the sequence in which buffers are stored in message memory 300 of communications module 100, the sequence in which the buffers are stored in message memory 802 is determined by arbiter 810. Independent of the sequence in which buffers are stored in message memory 300 of communications module 100, the sequence in which the buffers are stored in message memory 802 is determined by state machine 812, and could, for instance, be configured by host CPU 102.

The transmission of the buffers written by host CPU 102 into DPRAM 802 takes place in the same way as the reading. In contrast to reading, the buffer to be sent is determined by the evaluation of DP/status/W register 814. The bit number in register 814 corresponds to the priority in the transmission. State machine 812 scans the bits of register 814 from bottom to top. The corresponding buffer to the first bit set to “1” is transmitted from DPRAM 802 into message memory 300 of communications module 100. When the transmission has taken place, the appertaining bit in DP/status/W register 814 and the buffer number are written into DP/R-pos register 818. This procedure is carried out continuously. All buffers marked “1” are transmitted according to their priority from DPRAM 802 to message memory 300 of FlexRay communications module 100. The configuration and the start and stop of the state machine takes place vis the MDTSN-config register.

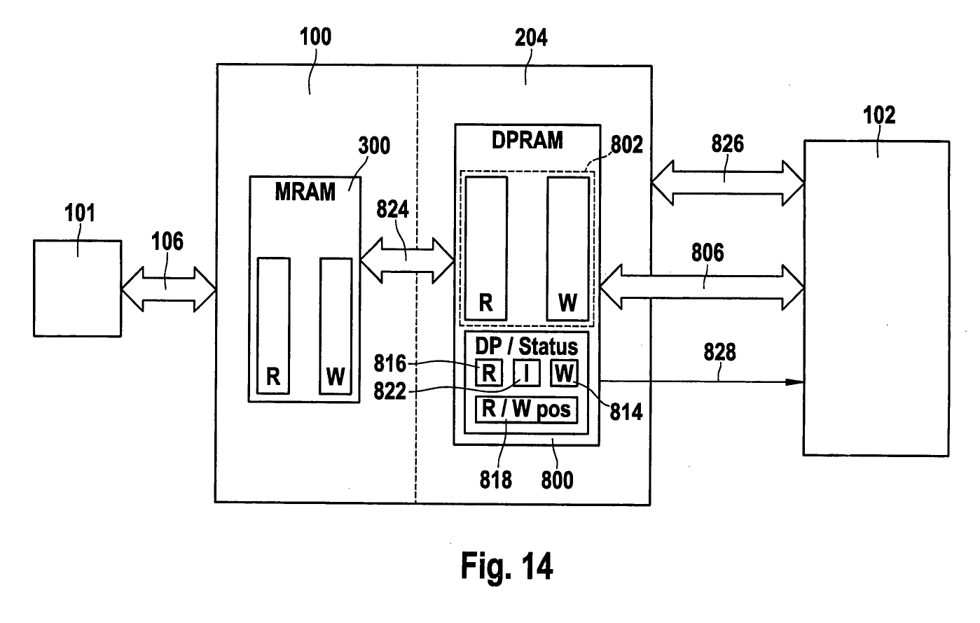

FIG. 14 shows a second exemplary embodiment of user interface 204 according to the present invention, which differs from the specific embodiment in FIG. 13 especially in that interface 204 is integrated into FlexRay communications module 100. Both exemplary embodiments, however, utilize the dual-port-based formulation of the present invention for the temporary storage of the data to be transmitted between FlexRay communications module 100 and FlexRay user 102. In the specific embodiment of FIG. 14, the data transmission can be coordinated and controlled by one or more of state machines 500-503 of the FlexRay communications module and/or by message handler 200, instead of by its own state machine 808 and its own arbiter 810 of interface 204 (cf. FIG. 13). Interface 204 according to the present invention therefore does not have to be designed completely to be completely self-sufficient, but is able to jointly use parts of communications module 100.

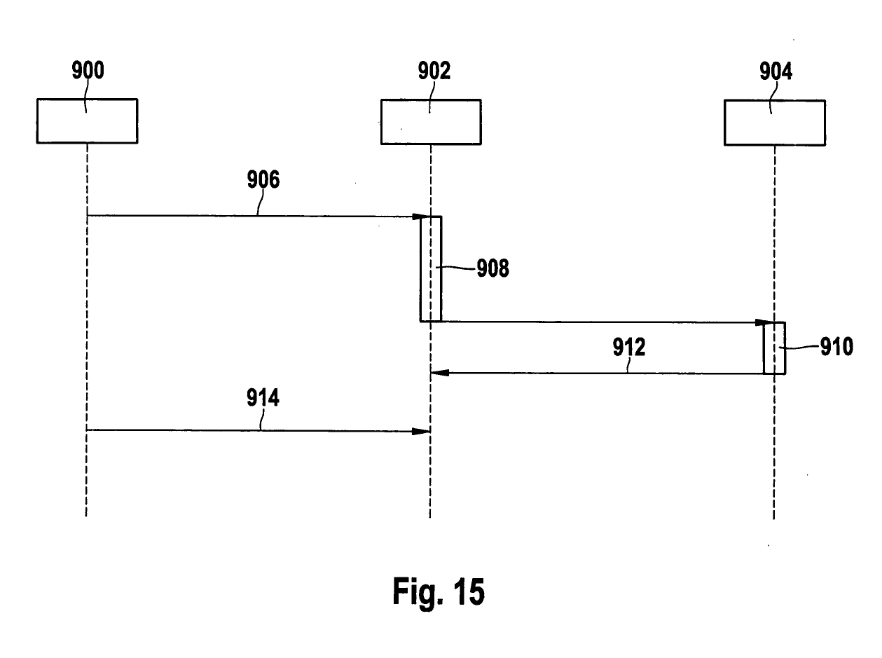

FIG. 15 shows a sequence diagram for a data transfer between message memory 300 of FlexRay communications module 100 and message memory 802 (e.g. DPRAM) of user interface 204. The control of message memory 300 of FlexRay communications module 100 by one or more state machines 500-503 is designated by 900. The control of message memory 802 of user interface 204 by one or more of state machines 500-503 and/or state machine 808 is designated by 902. The control of the status of message memory 802 of user interface 204 by one or more of state machines 500-503 and/or state machine 808 is designated by 904. Controller 900 of message memory 300 first of all transmits a signal 906 to controller 902 of message memory 802, according to which a buffer[x] has been received by communications connection 101 in message memory 300. Then, in step 908, buffer[x] of message memory 802 is updated using the content of buffer[x] from message memory 300. Thereafter, in a step 910, DPRAM-status-R-bit[x] is set in register 816 and an interrupt is generated if DPRAM-status-I-bit[x]=1. Then register DPRAM-status-R-pos 818 is updated with x. Finally, the end of the buffer transmission is announced to controller 902 by a signal 912. Subsequently, controller 900 transmits a signal 914 to controller 902, according to which a new buffer[y] has been received in message memory 300, and the steps that were carried out for buffer[x] are carried out for buffer[y]. This repeats until all buffers of a data cycle have been transmitted.

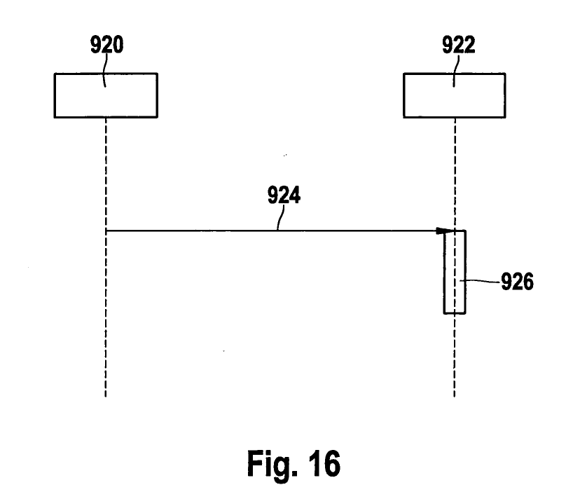

FIG. 16 shows a sequence diagram for a data transfer between message memory 802 (e.g. DPRAM) of user interface 204 and message memory 300 of FlexRay communications module 100. Write register W 814 of message memory 802 of user interface 204 is designated by 920. The control of message memory 802 of user interface 204 by one or more of state machines 500-503 and/or state machine 808 is designated by 922. At first it is checked in a step 924 whether one or more of the bits[0 . . . 127] of DPRAM-status-W register 814 is unequal to zero. Subsequently, in a step 926 DPRAM-status-Wbit[z] having the highest priority is ascertained for which corresponding bit DPRAM-status-W register[z] is set in register 814, that is, it is unequal to zero. Buffer[z] of message memory 300 of FlexRay communications module 100 is then updated using the content of buffer[z] of message memory 802 of user interface 204. In addition, register DPRAM-status-W-pos 818 is updated with y. Finally, the position DPRAM-status-W[z] is reset in register 814, that is, it is set to zero.

1-12. (canceled)

13. A user interface system, comprising:
a user interface between a FlexRay communications module, which is coupled to a FlexRay communications connection via which messages are transmitted, and which includes a message memory for providing temporary storage for messages from the FlexRay communications connection or for messages from the FlexRay communications connection, and a FlexRay user assigned to the FlexRay communications module; and
a storage device, for the user interface, for providing the temporary storage of the messages including at least one message memory, the device having a first connection to the FlexRay communications module and a second connection to the user.

14. The user interface system of claim 13, wherein the message memory of the user interface provides that access can be made to the message memory via one of the connections in one of a writing and a reading operation and simultaneously via the other connection in one of a reading and a writing operation.

15. The user interface system of claim 13, wherein the message memory of the user interface includes a dual-port RAM.

16. The user interface system of claim 13, wherein the user interface includes a state machine, which controls a transmission of messages from the message memory of the FlexRay communications module into the message memory of the user interface and from the message memory of the user interface into the message memory of the FlexRay communications module.

17. The user interface system of claim 13, wherein the user interface has an entity for regulating an access sequence to the message memory of the user interface.

18. The user interface system of claim 13, wherein the message memory of the user interface has a write area, in which messages to be transmitted via the FlexRay communications connection are stored, and has a read area, in which messages received by the FlexRay communications connection are stored.

19. The user interface system of claim 13, wherein registers are assigned to the message memory of the user interface, and a write register is assigned to a write area of the message memory and a read register is assigned to a read area of the message memory.

20. The user interface system of claim 13, wherein the message memory of the user interface has sufficient storage space to store therein at least the data of one transmission cycle over the FlexRay communications connection.

21. The user interface system of claim 20, wherein a transmission cycle over the FlexRay communications connection is subdivided into a plurality of data frames, and the message memory of the user interface has sufficient storage space to store therein at least the data frames in their maximal size of a transmission cycle.

22. The user interface system of claim 21, wherein the message memory of the user interface has sufficient storage space to store therein 128 data frames in their maximal size.

23. The user interface system of claim 19, wherein the registers assigned to the message memory of the user interface have a size of at least one of (i) 1 bit per data frame and (ii) 128 bits per data frame.

24. A method for transmitting messages, the method comprising:
transmitting messages between a FlexRay communications module which is connected to a FlexRay communications connection via which messages are transmitted;
using a message memory to temporarily store messages from the FlexRay communications connection or for the FlexRay communications connection;
providing a FlexRay user, assigned to the FlexRay communications module, via a user interface; and
temporarily storing the messages to be transmitted between the FlexRay communications module and the user in a device of the user interface for temporarily storing the messages, the device including at least one message memory which can be accessed simultaneously by the FlexRay communications module and the user.
